(19) United States
(12) Patent Application Publication
(10) Pub. No.: US 2016/0119927 A1
(43) Pub. Date: Apr. 28, 2016

(54) OFDMA RESOURCE ASSIGNMENT RULES TO ACHIEVE ROBUSTNESS

(71) Applicant: NEWRACOM, INC., Irvine, CA (US)

(72) Inventor: Ahmad Reza HEDAYAT, Irvine, CA (US)

(21) Appl. No.: 14/923,335

(22) Filed: Oct. 26, 2015

Related U.S. Application Data
(60) Provisional application No. 62/068,594, filed on Oct. 24, 2014.
(60) Provisional application No. 62/146,828, filed on Apr. 13, 2015.

(51) Int. Cl. H04W 72/04; H04W 72/12

(52) U.S. Cl. CPC H04W 72/0453; H04W 72/12

(57) ABSTRACT

A method for a wireless communications system in which an access point wirelessly communicates with a plurality of stations over a wireless channel includes transmitting a frame, including a schedule, from the access point to a plurality of stations, the schedule including assignments of one or more sub-bands in at least one sub-channel of the wireless channel to each station in the plurality of stations. Each station in the plurality of stations uses the assigned sub-band for a multi-user, simultaneous communication with the access point.

### CROSS-REFERENCE TO RELATED APPLICATION

This application claims priority to and the benefit of U.S. Provisional Application No. 62/068,594, filed on Oct. 24, 2014, and U.S. Provisional Application No. 62/146,828, filed on Apr. 13, 2015, the entire contents of both of which are incorporated herein by reference.

### TECHNICAL FIELD

The technology described herein relates generally to wireless networking. More particularly, the technology relates to stations transmitting energy on a plurality of uplink sub-bands.

### BACKGROUND

Wireless LAN (WLAN) devices are currently being deployed in diverse environments. Some of these environments have large numbers of access points (APs) and non-AP stations in geographically limited areas. Increased interference from neighboring devices gives rise to performance degradation. In addition, WLAN devices are increasingly required to support a variety of applications such as video, cloud access, and offloading. In particular, video traffic is expected to be the dominant type of traffic in many high efficiency WLAN deployments. With the real-time requirements of some of these applications, WLAN users demand improved performance in delivering their applications, including improved power consumption for battery-operated devices.

A WLAN is being standardized by the IEEE (Institute of Electrical and Electronics Engineers) Part 11 under the name of “Wireless LAN Medium Access Control (MAC) and Physical Layer (PHY) Specifications.” A series of standards have been adopted as the WLAN evolved, including IEEE Std 802.11™-2012 (March 2012) (hereinafter, IEEE Std 802.11). The IEEE Std 802.11 was subsequently amended by IEEE Std 802.11ae™-2012, IEEE Std 802.11aa™-2012, IEEE Std 802.11ad™-2012, and IEEE Std 802.11ac™-2013 (hereinafter, IEEE 802.11 ac).

Recently, an amendment focused on providing a high efficiency WLAN in high-density scenarios is being developed by the IEEE 802.1 lax task group. The 802.11.ax amendment focuses on improving metrics that reflect user experience, such as average per station throughput, the 5th percentile of per station throughput of a group of stations, and area throughput. Improvements will be made to support environments such as wireless corporate offices, outdoor hotspots, dense residential apartments, and stadiums.

New multiuser transmission technologies such as Uplink (UL) Multi-User (MU) Multiple-input Multiple-output (MIMO) and UL MU Orthogonal Frequency-Division Multiple Access (OFDMA), have received much interest for next-generation Wi-Fi technology. Particularly, OFDMA technology has potential since it does not require an antenna array at an AP.

In OFDMA, several OFDM symbols are sent consecutively at each of a plurality of frequencies. Hence, OFDMA has a frequency or subcarrier dimension and a time, or OFDM symbol index, dimension. Thus, OFDMA uses two-dimensional (2D) time-frequency resources, and a subset of the 2D resources are assigned for unicasting a packet to or from a client.

While it is possible to assign arbitrary time-frequency regions to each Station (STA) that participates in a given UL OFDMA PLCP Protocol Data Unit (PPDU), there are concerns related to how legacy STAs perceive a MU PPDU. These concerns are particularly acute with respect to the high density deployments envisioned by the 802.11.ax standard.

Some legacy OFDM devices operate based on CSMA rules. When CSMA devices sense a low level of energy on a medium, they may assume that the medium is available, start a backoff procedure, and then send a pending packet. While this behavior has not been particularly troublesome in the past, with the presence of OFDMA PPDUs, legacy OFDM devices may send packets when they see that the energy (e.g. from an OFDMA PPDU) within their neighborhood is lower than a threshold value. In some situations, the legacy devices could transmit on a frequency resource that is in use by a hidden node, resulting in a collision with an ongoing uplink OFDMA PPDU. The situation is more likely when a hidden node problem is present and when a set of STAs send an UL OFDMA PPDU in a set of frequency channels. In this situation, there is a growing chance that some of the STAs appear as hidden nodes to some nearby STAs on a particular channel of the set of the channels.

### SUMMARY

A method for a wireless communications system in which an access point wirelessly communicates with a plurality of stations over a wireless channel includes transmitting a frame including a schedule from the access point to a plurality of stations, the schedule including assignments of one or more sub-bands in at least one sub-channel of the wireless channel to each station in the plurality of stations, wherein each station in the plurality of stations uses the assigned sub-band for a multi-user, simultaneous communication with the access point.

In an embodiment, the wireless channel includes a plurality of sub-channels, and one or more sub-bands are assigned to each station in the plurality of stations from each of the plurality of sub-channels such that the each station in the plurality of stations is assigned at least one sub-band in each of the plurality of sub-channels. Each sub-channel in the plurality of sub-channels may be a 20 MHz channel.

In an embodiment, the wireless channel includes a plurality of sub-channels, and sub-bands in one or more sub-channels of the plurality of sub-channels are assigned to at least two separate stations in the plurality of stations.

In an embodiment, one sub-channel in the plurality of sub-channels is a primary sub-channel such that all transmissions on the wireless channel includes the primary sub-channel, and the assignment of sub-bands, in one or more sub-channels of the plurality of sub-channels to at least two separate stations in the plurality of stations, prioritizes the primary sub-channel over the other sub-channels in the plurality of sub-channels.

In an embodiment, one sub-channel in the plurality of sub-channels is a primary sub-channel such that all transmissions on the wireless channel includes the primary sub-channel, and the assignment of sub-bands, in one or more sub-channels of the plurality of sub-channels to at least two separate stations in the plurality of stations, prioritizes a sub-channel other than the primary sub-channel.

In an embodiment, (1) one sub-channel in the plurality of sub-channels is a primary sub-channel such that all transmissions on the wireless channel includes the primary sub-channel and (2) one sub-channel in the plurality of sub-channels is a secondary sub-channel such that all transmissions that are double a bandwidth of the primary sub-channel includes the secondary sub-channel, and the assignment of sub-bands, in one or more sub-channels of the plurality of sub-channels to at least two separate stations in the plurality of stations, prioritizes the secondary sub-channel over the other sub-channels in the plurality of sub-channels.

In an embodiment, the method for the wireless communications system includes determining a set of stations in the plurality of stations with a highest signal strength over a period of time, and one or more stations from the set of stations is assigned to one or more sub-channels in the plurality of sub-channels.

In an embodiment, one sub-channel in the plurality of sub-channels is a primary sub-channel such that all transmissions on the wireless channel includes the primary sub-channel, and the assignment of the one or more stations from the set of stations to one or more sub-channels in the plurality of sub-channels prioritizes the primary sub-channel over the other sub-channels in the plurality of sub-channels.

In an embodiment, the schedule is represented in one of (1) a trigger frame, which schedules an uplink transmission from the plurality of stations, and (2) a signaling field of a downlink multi-user transmission from the access point to the plurality of stations. The wireless channel may include a plurality of sub-channels, and at least two stations in the plurality of stations may be assigned to each sub-channel in the plurality of sub-channels.

A method for a wireless communications system in which an access point wirelessly communicates with a plurality of stations includes transmitting a frame including a schedule from the access point to a plurality of stations, the schedule including assignment of at least one station in the plurality of stations to at least one sub-band in each sub-channel of a wireless channel occupied by the frame, and each station in the plurality of stations uses the assigned sub-band for a multi-user, simultaneous communication with the access point.

In an embodiment, each sub-channel of the wireless channel is assigned at least one common station from the plurality of stations.

In an embodiment, each sub-channel of the wireless channel is assigned a different station from the plurality of stations.

In an embodiment, at least two sub-channels of the wireless channel are assigned different stations from the plurality of stations.

In an embodiment, the schedule includes assignment of at least two stations in the plurality of stations to at least two sub-bands in each sub-channel of a wireless channel occupied by the frame.

The method may further include determining a set of stations in the plurality of stations with a highest signal strength over a period of time, and one or more stations from the set of stations may be assigned to one or more sub-channels in the plurality of sub-channels.

In an embodiment, one sub-channel in the plurality of sub-channels is a primary sub-channel such that all transmissions on the wireless channel includes the primary sub-channel, and the assignment of the one or more stations from the set of stations to one or more sub-channels in the plurality of sub-channels prioritizes the primary sub-channel over the other sub-channels in the plurality of sub-channels.

### BRIEF DESCRIPTION OF THE DRAWINGS

FIG. 1 is a schematic block diagram of a wireless device according to an embodiment.

FIG. 2 is a schematic block diagram of a transmitting signal processing unit of a wireless device according to an embodiment.

FIG. 3 is a schematic block diagram of a received signal processing unit according to an embodiment.

FIG. 4 illustrates Inter-Frame Space (IFS) relationships in a wireless LAN according to an embodiment.

FIG. 5 illustrates wireless communication involving three stations.

FIG. 6 illustrates block ACK request (BAR) frames according to an embodiment.

FIG. 7 illustrates block ACK request (BAR) frames according to an embodiment.

FIG. 8A illustrates coverage areas and sub-channel assignments of stations in a Basic Service Set (BSS).

FIG. 8B illustrates coverage areas and sub-channel assignments of the stations in the BSS according to an embodiment.

FIG. 9 illustrates assignments of resources of Up-Link (UL) OFDMA PPDUs to stations according to an embodiment.

FIG. 10 illustrates assignments of resources of Up-Link (UL) OFDMA PPDUs to stations according to an embodiment.

FIG. 11 illustrates assignments of resources of Up-Link (UL) OFDMA PPDUs to stations according to an embodiment.

FIG. 12 illustrates assignments of resources of UL OFDMA PPDUs to stations according to another embodiment.

FIG. 13 illustrates assignments of resources of UL OFDMA PPDUs to stations according to another embodiment.

FIG. 14 illustrates assignments of resources of UL OFDMA PPDUs to stations according to another embodiment.

FIG. 15 illustrates assignments of resources of UL OFDMA PPDUs to stations according to another embodiment.

FIG. 16 illustrates assignments of resources of UL OFDMA PPDUs to stations according to another embodiment.

FIG. 17 illustrates a process for assigning frequency resources to a plurality of stations according to an embodiment.

### DETAILED DESCRIPTION

Embodiments of the present disclosure relate generally to wireless networking, and more particularly, to allocation of resources of an Orthogonal Frequency Division Multiple Access (OFDMA) frame to stations.

In the following detailed description, certain illustrative embodiments have been illustrated and described. As those skilled in the art would realize, these embodiments may be modified in various different ways without departing from the scope of the present disclosure. Accordingly, the drawings and description are to be regarded as illustrative in nature and not restrictive. Like reference numerals designate like elements in the specification.

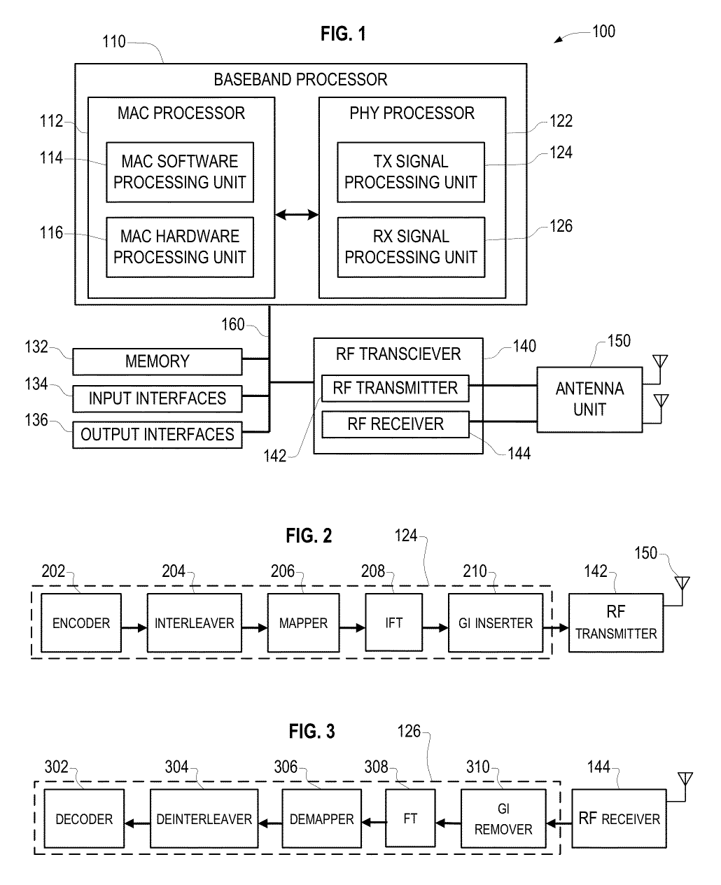

FIG. 1 illustrates a schematic block diagram of a wireless device 100 according to an embodiment. The wireless or WLAN device 100 may be included in any device in a basic service set (BSS), e.g., an Access Point (AP) or a station (STA). The WLAN device 100 includes a baseband processor 110, a radio frequency (RF) transceiver 140, an antenna unit 150, a storage device (e.g., memory) 131, one or more input interfaces 134, and one or more output interfaces 136. The baseband processor 110, the memory 132, the input interfaces 134, the output interfaces 136, and the RF transceiver 140 may communicate with each other via a bus 160.

The baseband processor 110 performs baseband signal processing, and includes a MAC processor 112 and a PHY processor 122.

In an embodiment, the MAC processor 112 includes a MAC software processing unit 114 and a MAC hardware processing unit 116. The storage device (or memory) 132 may be a non-transitory computer readable medium that stores software (e.g., computer programming instructions) hereinafter referred to as “MAC software”. The MAC software processing unit 114 executes the MAC software to implement a first plurality of functions of the MAC layer. The MAC hardware processing unit 116 may implement a second plurality of functions of the MAC layer in special-purpose hardware, hereinafter referred to “MAC hardware.” However, the MAC processor 112 is not limited thereto. For example, the MAC processor 112 may be configured to perform the first and second plurality of functions entirely in software or entirely in hardware according to various implementations.

The PHY processor 122 includes a transmitting signal processing unit 124 and a receiving signal processing unit 126. The PHY processor 122 implements a plurality of functions of the PHY layer. These functions may be performed in software, hardware, or a combination thereof according to implementation. In an embodiment, the PHY processor 122 may be configured to generate channel state information (CSI) according to information received from the RF transceiver 140.

The channel state information (CSI) may include one or more of a Received Signal Strength Indication (RSSI), a Signal to Interference and Noise Ratio (SINR), a Modulation and Coding Scheme (MCS), and a Number of Spatial Streams (NSS). CSI may be generated for one or more of a frequency block, a sub-band within the frequency block, a subcarrier within a frequency block, a receiving antenna, a transmitting antenna, and combinations of a plurality thereof.

The RF transceiver 140 includes an RF transmitter 142 and an RF receiver 144. The RF transceiver 140 is configured to transmit first information received from the baseband processor 110 to the WLAN, and provide second information received from the WLAN to the baseband processor 110.

The antenna unit 150 includes one or more antennas. When Multiple-Input Multiple-Output (MIMO) or Multi-User MIMO (MU-MIMO) is used, the antenna unit 150 may include a plurality of antennas.

The input interfaces 134 receive information from a user, and the output interfaces 136 output information to the user. The input interfaces 134 may include one or more of a keyboard, keypad, mouse, touchscreen, touch screen, microphone, and the like. The output interfaces 136 may include one or more of a display device, touch screen, speaker, and the like.

As described herein, many functions of the WLAN device 100 may be implemented in either hardware or software, and which functions are implemented in software and which functions are implemented in hardware will vary according to constraints imposed on a design. The constraints may include one or more of design cost, manufacturing cost, time to market, power consumption, available semiconductor technology, and so on.

As described herein, a wide variety of electronic devices, circuits, firmware, software, and combinations thereof may be used to implement the functions of the components of the WLAN device 100. Furthermore, the WLAN device 100 may include other components, such as application processors, storage interfaces, clock generator circuits, power supply circuits, and the like, which have been omitted in the interest of brevity.

FIG. 2 illustrates a transmitting signal processing unit of a wireless device according to an embodiment, e.g., a transmitting signal processing unit 124 of a WLAN device 100. In an embodiment, the transmitting signal processing unit 124 includes an encoder 202, an interleaver 204, a mapper 206, an inverse Fourier transformer (IFT) 208, and a guard interval (GI) inserter 210.

The encoder 202 encodes input data. For example, the encoder 202 may be a forward error correction (FEC) encoder. The FEC encoder may include a binary convolutional code (BCC) encoder followed by a puncturing device, or may include a low-density parity-check (LDPC) encoder.

The transmitting signal processing unit 124 may further include a scrambler for scrambling the input data before the encoding to reduce the probability of long sequences of 0s or 1s. If BCC encoding is used in the encoder 202, the transmitting signal processor 200 may further include an encoder parser for demultiplexing the scrambled bits among a plurality of BCC encoders. If LDPC encoding is used in the encoder, the transmitting signal processing unit 124 may not use the encoder parser.

The interleaver 204 interleaves bits of each stream output from the encoder 202 to change order of bits. Interleaving may only be applied when BCC encoding is used. The mapper 206 maps the sequence of bits output from the interleaver to constellation points. If LDPC encoding is used in the encoder 202, the mapper 204 may perform LDPC tone mapping in addition to constellation mapping.

When the transmitting signal processing unit 124 is included in a MIMO or MU-MIMO device, the processor may use a plurality of interleavers 204 and a plurality of mappers 206 corresponding to a number of NSS of spatial streams. In such an embodiment, the transmitting signal processing unit 124 may further include a stream parser for dividing outputs of the BCC encoders or the LDPC encoder into blocks that are sent to different interleavers 204 or mappers 206. The transmitting signal processing unit 124 may further include a space-time block code (STBC) encoder for spreading the constellation points from the NSS spatial streams into NSTS space-time streams and a spatial mapper for mapping the space-time streams to transmit chains. The spatial mapper may use direct mapping, spatial expansion, or beamforming.

The IFT 208 converts a block of the constellation points output from the mapper 206 or the spatial mapper to a time domain block (i.e., a symbol) by using an inverse discrete Fourier transform (IDFT) or an inverse fast Fourier transform (IFFT). If an STBC encoder and a spatial mapper are used, an inverse Fourier transformer 208 may be provided for each transmit chain.

When transmitting signal processing unit 124 is included in a MIMO or MU-MIMO device, the transmitting signal processing unit 124 may insert cyclic shift diversities (CSDs) to prevent unintentional beamforming. The CSD insertion may occur before or after the inverse Fourier transform. The CSD may be specified per transmit chain or may be specified per space-time stream. Alternatively, the CSD may be applied as a part of the spatial mapper.

When transmitting signal processing unit 124 is included in a MIMO or MU-MIMO device, some blocks before the spatial mapper may be provided for each user.

The Guard Interval (GI) inserter 210 prepends a GI to a symbol. The transmitting signal processing unit 124 may optionally perform windowing to smooth edges of each symbol after inserting the GI. The RF transmitter 142 converts the symbols into an RF signal and transmits the RF signal via the antenna unit 150. When transmitting signal processing unit 124 is included in a MIMO or MU-MIMO device, a separate GI inserter 210 and RF transmitter 142 may be provided for each transmit chain.

FIG. 3 is a schematic block diagram of a received signal processing unit according to an embodiment, e.g. a received signal processing unit 126 in a WLAN device 100. In an embodiment, a receiving signal processing unit 126 includes a GI remover 310, a Fourier transformer (FT) 308, a demapper 306, a deinterleaver 304, and a decoder 302.

An RF receiver 144 receives an RF signal via the antenna unit 150 converts an RF signal into symbols. The GI remover 310 removes the GI from the symbol. When the WLAN device 100 is a MIMO or the MU-MIMO device, an RF receiver 150 and a GI remover 310 may be provided for each receive chain.

The Fourier Transformer (FT) 308 converts a symbol into a block of constellation points by using a discrete Fourier transform (DFT) or a fast Fourier transform (FFT). A Fourier transformer 308 may be provided for each receive chain.

When transmitting signal processing unit 124 is included in a MIMO or MU-MIMO device, the receiving signal processing unit 126 may include a spatial demapper for converting the Fourier transformed receiver chains to constellation points of the space-time streams, and an STBC decoder for despreading the constellation points from the space-time streams into the spatial streams.

The demapper 306 demaps the constellation points output from the Fourier transformer 308 or a STBC decoder to the bit streams. If the LDPC encoding is used, the demapper 306 may further perform LDPC tone demapping before the constellation demapping. The deinterleaver 304 deinterleaves the bits of each stream output from the demapper 306. Deinterleaving may only be applied when BCC encoding is used.

When transmitting signal processing unit 124 is included in a MIMO or MU-MIMO device, the receiving signal processing unit 126 may use a plurality of demappers 306 and a plurality of deinterleavers 304 corresponding to the number of spatial streams. In this case, the receiving signal processing unit 126 may further include a stream deparser for combining the streams output from the deinterleavers 304.

The decoder 302 decodes streams output from the deinterleaver 304 or the stream deparser. For example, the decoder 302 may be an FEC decoder. The FEC decoder may include a BCC decoder or an LDPC decoder.

The receiving signal processing unit 126 may further include a descrambler for descrambling the decoded data. If BCC decoding is used in the decoder, the receiving signal processing unit 126 may further include an encoder deparser for multiplexing the data decoded by a plurality of BCC decoders. If LDPC decoding is used in the decoder, the receiving signal processing unit 126 may not use the encoder deparser.

A data frame, a control frame, or a management frame may be exchanged between WLAN devices.

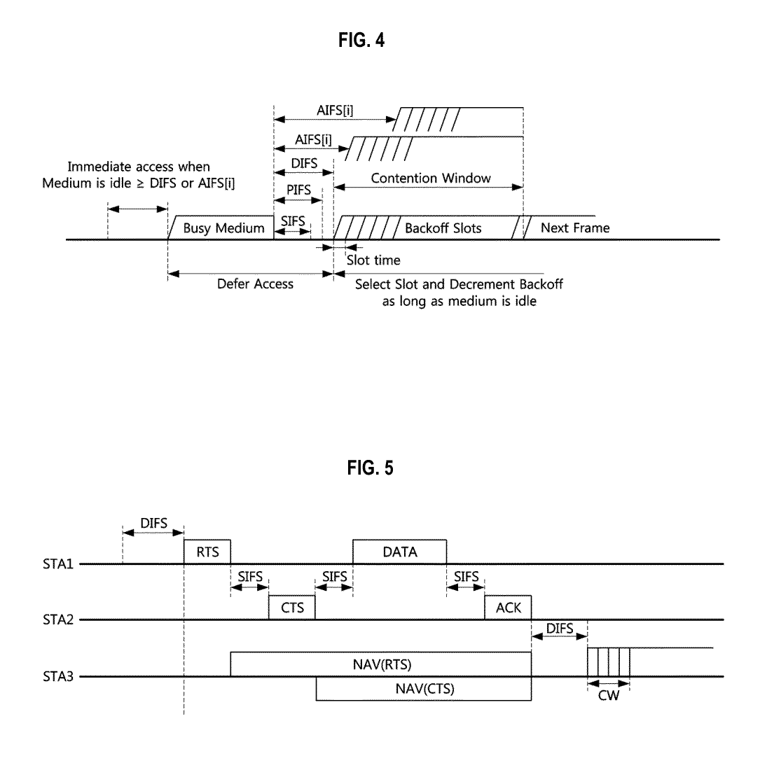

FIG. 4 illustrates interframe space (IFS) relationships in a WLAN. A STA shall determine that the medium is idle through the use of a Carrier Sense (CS) function for a specified IFS interval. The use of different IFSs may provide priority levels for access to the wireless medium, as described in IEEE Std 802.11™-2012.

The IFSs include a Short InterFrame Space (SIFS), a Point Coordination Function (PCF) InterFrame Space (PIFS), a Distributed Coordination Function (DCF) InterFrame Space (DIFS), an Arbitration InterFrame Space (AIFS), and an Extended InterFrame Space (EIFS).

A data frame is used for transmission of data forwarded to a higher layer. A WLAN device transmits the data frame after performing backoff if a distributed coordination function IFS (DIFS) has elapsed from a time when the medium has been idle. The management frame is used for exchanging management information that is not forwarded to the higher layer. Several subtypes of management frames are a beacon frame, an association request/response frame, a probe request/response frame, and an authentication request/response frame.

A control frame is used for controlling access to a medium. Subtypes of control frames include a Request Ro Send (RTS) frame, a Clear To Send (CTS) frame, and an acknowledgement (ACK) frame. When a control frame is not transmitted in response to another frame, a WLAN device transmits a control frame after performing backoff if the DIFS has elapsed. When a control frame is transmitted in response to another frame, the WLAN device transmits the control frame without performing backoff if a short IFS (SIFS) has elapsed. The type and subtype of frame may be identified by a type field and a subtype field in a frame control field.

On the other hand, a Quality of Service (QoS) STA may transmit the frame after performing backoff if an arbitration IFS (AIFS) for access category (AC), or AIFS[AC], has elapsed. In this case, the data frame, the management frame, or a control frame which is not a response frame may use the AIFC[AC].

FIG. 5 is a schematic diagram that illustrates a Carrier Sense Multiple Access/Collision Avoidance (CSMA/CA) based frame transmission procedure for avoiding collision between frames in a channel.

Referring FIG. 5, STA1 is a WLAN transmitter device that transmits data, STA2 is a WLAN receiver device that receives data, and STA3 is a WLAN device which may be located at an area where a frame transmitted from the STA1 and/or a frame transmitted from the STA2 can be received by the WLAN device.

The STA1 may determine whether the channel is busy by carrier sensing. The STA1 may determine the channel occupation based on an energy level on the channel, correlation of signals in the channel, or by using a network allocation vector (NAV) timer.

When the STA1 determines that the channel is not used by other devices during a DIFS (that is, that the channel is idle), the STA1 may transmit an RTS frame to the STA2 after performing backoff. Upon receiving the RTS frame, the STA2 may transmit a CTS frame after a SIFS as a response of the CTS frame.

When the STA3 receives the RTS frame, it may set the NAV timer for a transmission duration of subsequently transmitted frames (for example, a duration of SIFS+CTS frame duration+SIFS+data frame duration+SIFS+ACK frame duration) by using duration information included in the RTS frame. When the STA3 receives the CTS frame, it may set the NAV timer for a transmission duration of subsequently transmitted frames (for example, a duration of SIFS+data frame duration+SIFS+ACK frame duration) by using duration information included in the CTS frame. Upon receiving a new frame before the NAV timer expires, the STA3 may update the NAV timer by using duration information included in the new frame. The STA3 does not attempt to access the channel until the NAV timer expires.

When the STA1 receives the CTS frame from the STA2, STA1 may transmit a data frame to the STA2 after a SIFS, which begins at a time when the CTS frame is completely received. Upon successfully receiving the data frame, the STA2 may transmit an ACK frame as a response of the data frame after SIFS elapses.

When the NAV timer expires, the STA3 may determine whether the channel is busy by carrier sensing. Upon determining that the channel is in use by the other devices during DIFS after the NAV timer has expired, the STA3 may attempt to access the channel after a contention window (CW) according to random backoff elapses.

The explanation above provides that an ACK frame is sent to acknowledge the successful reception of a frame by the recipient. In an embodiment, it is also possible that the recipient sends a frame called Block Acknowledgment (Block Ack, BlockAck or BA) to acknowledge the successful reception of multiple consecutive frames at once. The Block Ack mechanism improves channel efficiency by aggregating several acknowledgments into one frame.

There are two types of Block Ack mechanisms: immediate and delayed Immediate Block Ack is suitable for high-bandwidth, low-latency traffic while the delayed Block Ack is suitable for applications that tolerate moderate latency. In the following description, the STA with data to send using the Block Ack mechanism may be referred to as the originator, and the receiver of that data as the recipient.

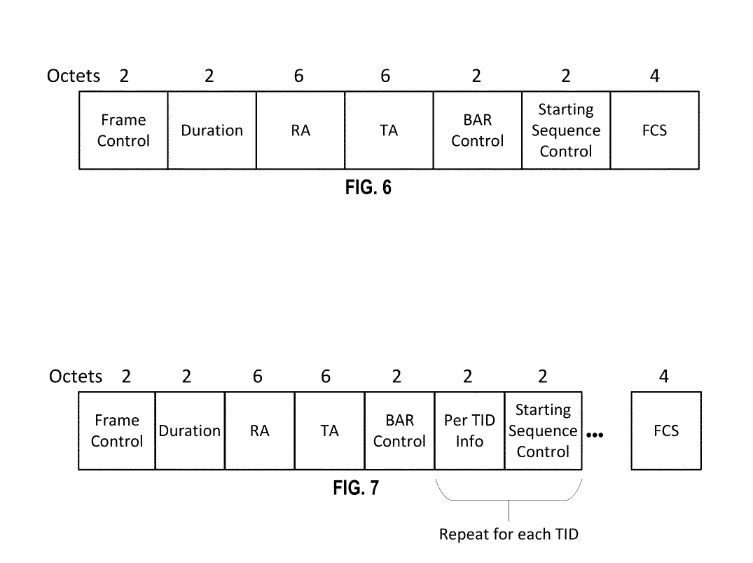

FIG. 6 shows BAR (Block Ack Request) frame and its components. FIG. 7 shows Multi-TID BAR frame. Both the BAR and Multi-TID BAR have the BAR Control field, which in an embodiment includes a Wideband BA Response field.

The PHY entity for 802.11 is based on OFDM or OFDMA. In OFDM and OFDMA PHY layers, a STA is capable of transmitting and receiving PPDUs that are compliant with the mandatory PHY specifications. A PHY specification defines a modulation and coding set (MCS) and a maximum number of spatial streams. Some PHY entities define downlink and/or uplink MU transmission with a maximum number of space-time streams per user and up to a fixed total number of space-time streams.

Some PHY entities define PPDUs that are individually addressed (where identification is based on Association Identifier (AID) or Partial AID) and some are group addressed (where identification is based on Group ID (GID). Some PHY entities provide support for 20 MHz, 40 MHz, 80 MHz and 160 MHz contiguous channel widths and for 80+80 MHz non-contiguous channel width.

The data subcarriers are modulated using binary phase shift keying (BPSK), quadrature phase shift keying (QPSK), 16-quadrature amplitude modulation (16-QAM), 64-QAM and 256-QAM. Forward error correction (FEC) coding (convolutional or LDPC coding) is used with coding rates of ½, ⅔, ¾ and ⅚.

In OFDMA, several OFDM symbols are sent consecutively using one or more subcarriers of a plurality of subcarriers. Therefore, transmissions have a first frequency or subcarrier dimension, and a second time or OFDM symbol index dimension. Hence there is a two-dimensional (2D) time-frequency resource where a subset of the 2D resource is assigned for unicasting a packet to or from a client. Although it is possible to assign arbitrary time-frequency regions to each STA that participates in a given UL OFDMA PPDU, there would be concerns related to efficiency as well as how legacy STAs perform carrier sensing (CS) of the MU PPDU.

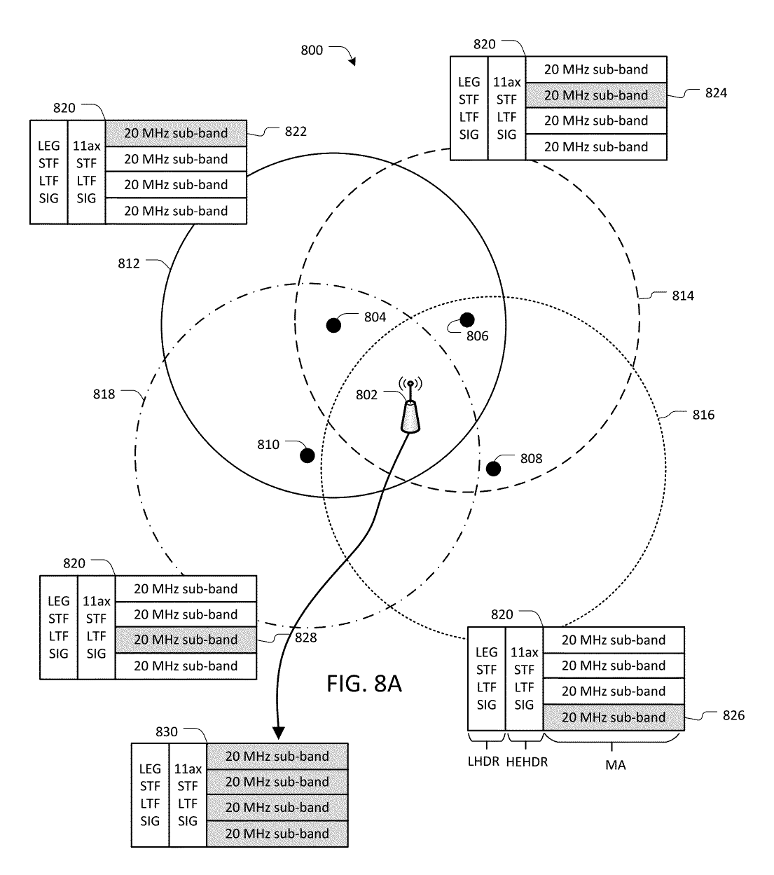

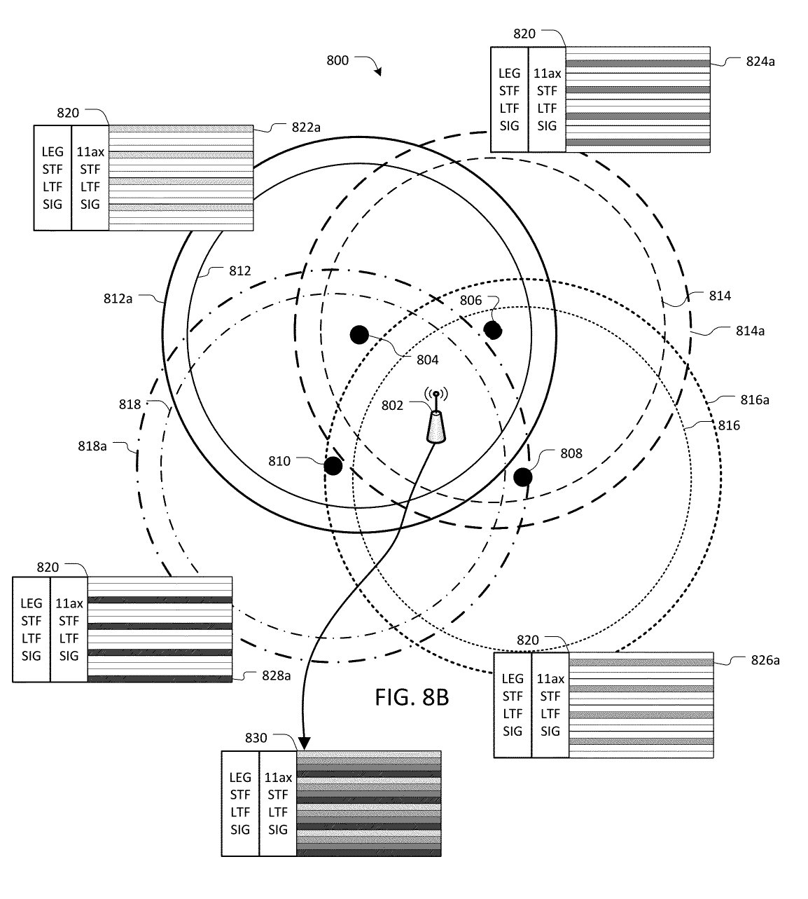

FIG. 8A illustrates a BSS 800 including first, second, third, and fourth STAs 804, 806, 808 and 810 that are each associated with an AP 802. The first to fourth STAs 804 to 810 have first, second, third, and fourth coverage areas 812, 814, 816 and 818, respectively.

Each of STAs 804 to 810 participates in the transmission of an 80 MHz UL PPDU 820. The 80 MHz UL PPDU 820 includes a Legacy physical layer convergence protocol (PLCP) header (LHDR) transmitted by each of the STAs 804 to 810 using the entire 80 MHz bandwidth of the 80 MHz UL PPDU 820, an High Efficiency PLCP header (HEHDR) transmitted by each of the STAs 804 to 810 using the entire 80 MHz bandwidth of the 80 MHz UL PPDU 820, and a multi-access portion MA.

In the illustrations of 80 MHz UL PPDU 820, as well as in other similar illustrations of PPDUs herein, a vertical axis corresponds to frequency (or, equivalently, a subcarrier index), and a horizontal axis corresponds to time (or a symbol index).

Each of STAs 804 to 810 transmits the multi-access portion MA of the 80 MHz UL PPDU 820 on a respective 20 MHz sub-channel. The sub-channel on which each STA transmits the multi-access portion of the PPDU on is shaded in gray in FIG. 8A as indicated in the PPDU 820 adjacent to each respective coverage area. Specifically, the first STA 804 transmits on a first sub-channel 822, which is the primary sub-channel, and the second, third, and fourth STAs 806, 808, and 810 transmit on second, third, and fourth sub-channels 824, 826, and 828, respectively. As described herein, the bandwidth of a sub-channel is 20 MHz. Also, while in FIG. 8 the assigned sub-bands to each STA is equal to a sub-channel, i.e. 20 MHz, it is a mere example and the proposed methods herein apply to whatever sub-bands that AP assigns to the STAs (e.g., 2 MHz, 4 MHz, and 8 MHz).

In the arrangement of FIG. 8A, the STAs 806, 808 and 810 do not transmit on the primary sub-channel while transmitting the multi-access portion of the 80 MHz UL PPDU 820. As a result, another STA that is outside the coverage area of STA 804 is not likely to see substantial energy levels on the primary channel during the time interval wherein the multi-access portion is transmitted. As a result, if the STA is sufficiently remote from STA 804, it may assume that the medium used by STA 804 is available, and could send frames that collide with the ongoing UL OFDMA PPDU. Such a scenario is especially likely when the remote STA is a legacy STA that comes out of the power save mode, that is, that begins performing carrier sensing of the medium, after the transmission of the Legacy PLCP header LHDR of the 80 MHz UL PPDU 820.

In the scenario of FIG. 8A, since each STA 804 to 810 transmits on only one 20 MHz sub-channel after the legacy and any other headers (e.g., 11ax PLCP headers), their respective coverage areas 812 to 818 are associated with the coverage of the particular sub-channel that they transmit on. FIG. 8A shows that a STA in the intersection of all the four coverage areas, which is a limited area around the AP 802, would sense that all four sub-bands are busy, as illustrated by received UL OFDMA PPDU 830. However, during the transmission of the multi-access portion of the 80 MHz UL PPDU 820, a STA outside of the limited area around AP 802 may determine that one or more of the sub-channels does not have energy above a threshold value, and may therefore assume the one or more sub-channels is available. When STAs in the neighborhood of an AP 802 have various interpretations of the availability of the medium, they could send frames which collide with an ongoing UL OFDMA PPDU.

In an embodiment, when a STA sends a reduced amount of power on each of a plurality of 20 MHz sub-channel instead of concentrating power in a minimal number of the 20 MHZ sub-channels, the coverage area of the STA in each sub-channel is reduced. For example, if a STA transmits in 5 MHz of spectrum in each of four 20 MHz sub-channels, the coverage may be reduced by 6 dB due to a ¼ power reduction relative to transmitting on the entire 20 MHz spectrum of a single one of the 20 MHz sub-channels. Therefore, in an embodiment, the STA may increase power levels by, for example, 3 dB or 6 dB, when data is transmitted on a portion of each a plurality of sub-channels. In an embodiment, transmission power is boosted such that total power limits imposed by a standard or standards body are not exceeded.

For example, FIG. 8B shows an 80 MHz UL OFDMA PPDU 820 wherein the first to fourth STAs 804 to 810 are assigned resources based on an embodiment of this disclosure. Each STA 804, 806, 808 and 810 has been assigned respective resources in each sub-channel of the multi-access portion of the 80 MHz PPDU 820. In FIG. 8B, the resources are indicated by various shades for each STA. STA 804 uses resources 822a, STA 806 uses resources 824a, STA 808 uses resources 826a, and STA 810 uses resources 828a. Accordingly, in the embodiment of FIG. 8B, each STA has a minimum bandwidth assignment in each of the four 20 MHz sub-bands.

In FIG. 8B, the lower line weight circles around each STA shows a first coverage area of each STA, which represents a coverage area that the STA would have if it transmits energy on each of a plurality of sub-channels as shown in FIG. 8A. In contrast, the darker circles represent a coverage area that would exist when the same amount of energy is concentrated in a single sub-channel. For example, STA 808 would have coverage area 816 if it transmits energy on portions of a respective plurality of 5 MHz sub-channels 828a after sending a legacy header and/or any other header (e.g., IEEE 802.11ax PLCP), while coverage area 816a represents the area that would be covered if energy were concentrated in a single 20 MHz sub-channel. By boosting signal strength as described above, a STA can achieve the larger coverage area expected by transmitting on a single sub-channel (e.g., coverage areas 812a, 814a, 816a and 818a) even when the STA transmits on a plurality of sub-channels.

As in FIG. 8A, received PPDU 830 represents AP 802's perception of channel occupancy on all bands. PPDUs 820 show assignments for associated STAs, while PPDU 830 shows the perception of channel occupancy of AP 802.

In an embodiment, a schedule transmitted by the AP to the STA is adapted to increase the coverage area of sub-channel frequencies in a multi-access portion of an uplink transmission. This can be accomplished, for example, by assigning more than one STA to transmit in a sub-band of a sub-channel of a multi-access portion of an uplink PPDU. The following figures illustrate various embodiments of adapting a schedule to increase the coverage area of sub-channel frequencies in uplink.

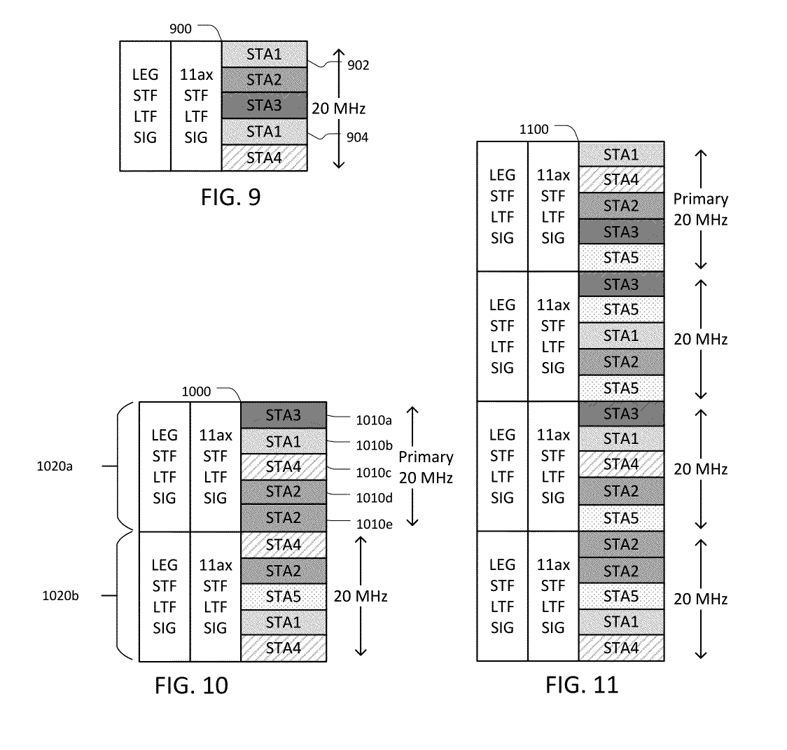

FIGS. 9-11 show embodiments of UL OFDMA PPDUs in which STA resource assignments during a multi-access portion of the PPDU are indicated by shaded rectangles. While FIGS. 9-16 show a UL OFDMA frame that is transmitted by a plurality of STAs to their associated AP, it is understood that right before the UL OFDMA frame the AP sends a trigger frame to the STAs, wherein the AP indicates the identifier of each of the STAs along with the scheduled sub-bands for each STA. FIG. 9 shows an example of assignments for a 20 MHz PPDU 900, FIG. 10 shows an example of assignments for a 40 MHz PPDU 1000, and FIG. 11 shows an example of assignments for an 80 MHz PPDU 1100. The transmissions may be normal scheduled data transmissions. However, in other embodiments, energy may be transmitted regardless of whether uplink data is scheduled. For example, null data may be transmitted to occupy a frequency band.

In an embodiment, scheduling UL OFDMA transmissions by a plurality of STAs may include scheduling the transmissions so as to increase the number of STA transmitting on each sub-channel (for example, for each 20 MHz sub-channel) during a multi-access portion of an UL OFDMA PPDU. For example, each STA may be scheduled to transmit in each 20 MHz sub-channel. In an embodiment, an AP may assign a STA to transmit energy on a sub-channel specifically so that energy from that STA is present in a sub-channel.

In an embodiment, the AP may schedule and assign resources among a plurality of STAs having data to upload so as to increase a total coverage area having energy above a threshold value in each sub-channel of a UL OFDMA PPDU during the multi-access portion of the UL OFDMA PPDU, wherein the total coverage area is a union of the coverage areas of each STA participating in the UL OFDMA PPDU. In an embodiment, the AP may schedule and assign resources among a plurality of STAs so that the total coverage area during the multi-access portion of the UL OFDMA PPDU includes substantially all of the coverage area of the AP.

In the 20 MHz UL OFDMA PPDU, FIG. 9 shows that resources in the multi-access portion of the UL PPDU is assigned to 4 STAs. STA1 has two assignments (902 and 904) in the 20 MHz primary sub-channel as shown. Although non-contiguous assignments are shown, in other embodiments, some STAs may have assignments that are twice as large, in comparison to other STAs, and these larger assignments are contiguous. Thus, in an embodiment, a STA may receive more than one assignment or a larger assignment in a given sub-channel of a primary Wi-Fi channel. Such an embodiment may be implemented when a data transmission is scheduled for STA1, but the data transmission has a relatively short duration. The second assignment 904 may extend for the entire duration of the multi-access portion of a PPDU, so that a hidden node that does not detect the short data transmission may detect the longer energy transmission.

In the 40 MHz UL OFDMA PPDU shown in FIG. 10, the assignment for STA1 is shown as an example. In particular, FIG. 10 shows an assignment of resources to STA1 in each of the two 20 MHz sub-channels 1020a and 1020b of the 40 MHz channel.

As illustrated in FIG. 10, a 40 MHz channel is divided into two sub-channels 1020a and 1020b, which are in turn each divided into five separate sub-bands 1010a to 1010e. Similarly, other sized channels may be divided into sub-channels, which are in turn divided into a plurality of sub-bands. In other embodiments, the size of a channel and the size of sub-bands in a sub-channel may differ from the specific examples provided in this disclosure.

Similarly, FIG. 11 shows an assignment for a STA (STA1) in every 20 MHz sub-channel of an 80 MHz UL OFDMA PPDU. In addition, FIG. 11 illustrates one way in which embodiments of the present disclosure differ from conventional practice. In a conventional system, a data transmission from STA1 that uses 20 MHz or less of bandwidth would be scheduled in a single sub-channel. In contrast, an embodiment of this disclosure may spread such a transmission across several sub-channels as shown by FIG. 11.

FIGS. 9-11 each show 20 MHz sub-channels that are divided into five sub-bands that have a bandwidth of 4 MHz. However, embodiments are not limited thereto. In other embodiments, a sub-channel may be divided into sub-bands of other bandwidths, and a STA may be assigned to other bandwidth sub-band such as 5 MHz or 10 MHz.

FIG. 12 shows an embodiment of an 80 MHz UL OFDMA PPDU 1200. In the embodiment of FIG. 12, every sub-band of the plurality of sub-channels in the 80 MHz channel has a different STA transmission. Put another way, FIG. 12 shows an embodiment in which each STA participating in the transmission of the UL OFDMA PPDU 1200 transmits energy on a respective sub-band of each of the 20 MHz sub-channels of the PPDU 1200.

In an embodiment, a STA may transmit on one or more sub-bands the STA has been assigned even when no data is waiting for transmission by the STA. Energy may be transmitted in accordance with FIG. 12 even when no conventional data transmissions are scheduled for one or more STA1 to STA5. For example, null data may be transmitted in order to occupy sub-bands.

In an embodiment, the STAs scheduled to participate in the transmission of the UL OFDMA PPDU 1200 are selected to maximize a total coverage area of the UL OFDMA PPDU 1200. In another embodiment, an AP schedules the STAs to participate in the transmission of the UL OFDMA PPDU 1200, and particular STAs are selected to produce a total coverage area of the UL OFDMA PPDU 1200 that includes a coverage area of the AP.

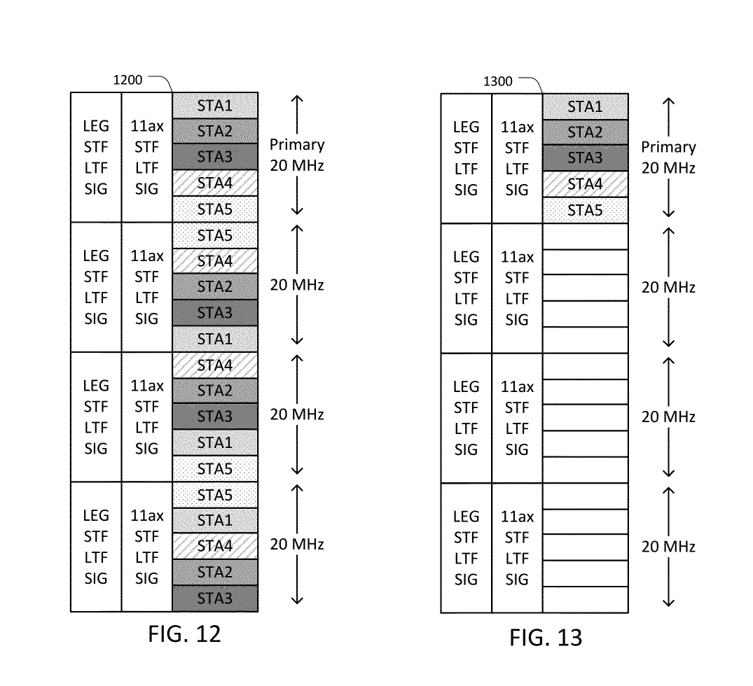

FIG. 13 shows an embodiment in which each of a plurality of STAs transmits energy in a primary sub-channel during the multi-access portion of an UL OFDMA PPDU 1300, but not necessarily in other non-primary sub-channels of the PPDU 1300. Thus, the embodiment of FIG. 13 represents a relaxation of the scheduling requirements of the embodiment of FIG. 12, in which the same plurality of STAs transmit energy in every sub-channel of the UL OFDMA PPDU 1200 during the multi-access portion of the PPDU 1200. In the embodiment of FIG. 13, no STA within the same BSS as the AP that scheduled the UL OFDMA PPDU 1300 would find the medium is available during the transmission of UL OFDMA PPDU 1300. This embodiment offers some relaxation for the UL OFDMA scheduler that resides in an AP relative to the embodiment of FIG. 12.

Although FIG. 13 shows no assignments of resources in non-primary sub-channels during the multi-access portion of the PPDU 1300, embodiments are not so limited. In embodiments of FIG. 13, various STA might have been scheduled by the AP, within the preceding Trigger frame, to transmit on various non-primary sub-channels so long as a plurality of STAs transmit on respective sub-bands of the primary sub-channel.

Although FIG. 13 shows an 80 MHz channel, embodiments are not so limited, and may apply to other channel sizes as well. Thus, in the embodiment of FIG. 13, energy is transmitted by a plurality of STA in a primary sub-channel of a channel that is sub-divided into a plurality of sub-channels.

In another embodiment, the following relaxation of the rules mentioned above may be used. In these embodiments, the AP may schedule an upcoming UL OFDMA PPDU as follows: the UL OFDMA sub-band assignment strategy (exercised in the AP scheduler and announced to the STAs within a trigger frame) is based on assigning at least two STAs per each 20 MHz sub-channel that the UL OFDMA PPDU is expected to operate. For instance, for an UL OFDMA PPDU with 40 MHz bandwidth, the AP assigns at least two STAs per secondary 20 MHz sub-channel and if possible (i.e., the total number of STAs in the UL OFDMA PPDU allows) and the AP assigns at least two STAs per the primary 20 MHz sub-channel. In another embodiment, the AP first schedules at least two STAs per primary 20 MHz sub-channel and if possible then schedules at least two STAs on the secondary 20 MHz sub-channel. Thus, the priority of channel assignment may shift or focus on one particular sub-channel (e.g., the primary sub-channel receives priority or the secondary channel received priority).

The above rules would decrease the chance of hidden nodes on each of the 20 MHz sub-channels. In particular, if two or more STAs are assigned to the primary 20 MHz sub-channel, then the chance of hidden node may decrease. In another instance, for an UL OFDMA PPDU with a 80 MHz bandwidth, the AP assigns at least two STAs per secondary 20 MHz sub-channel and if possible (i.e., the total number of STAs in the UL OFDMA PPDU allows) the AP assigns at least two STAs per each 3rd and 4th 20 MHz sub-channel and if possible (i.e., the total number of STAs in the UL OFDMA PPDU allows) the AP assigns at least two STAs per the primary 20 MHz sub-channel.

In yet another instance, for an UL OFDMA PPDU with 160 MHz bandwidth, whether it is contiguous or non-contiguous (i.e., 80+80 MHz or 160 MHz) the AP assigns at least assigns two STAs per secondary 20 MHz sub-channel and if possible (i.e., the total number of STAs in the UL OFDMA PPDU allows) the AP assigns at least two STAs per each 3rd and 4th 20 MHz sub-channel (i.e., the second 40 MHz band) and if possible the AP assigns at least two STAs per each 20 MHz sub-channel in the secondary 80 MHz sub-channel and if possible the AP assigns at least two STAs per the primary 20 MHz sub-channel. In some embodiments, the AP gives priority to the primary 20 MHz sub-channel and as the first priority in the UL OFDMA sub-band assignment strategy, the AP assigns at least two STAs per primary 20 MHz sub-channel and as the second priority in the UL OFDMA sub-band assignment strategy, the AP assigns at least two STAs per secondary 20 MHz sub-channel.

In the above embodiments, the emphasis was that the AP assigns at least two STAs per the 20 MHz (based on the priority explained above). However, in some embodiments, the AP might have several STAs to assign in the upcoming UL OFDMA and enough STAs such that the AP can assign more than two STAs per 20 MHz band.

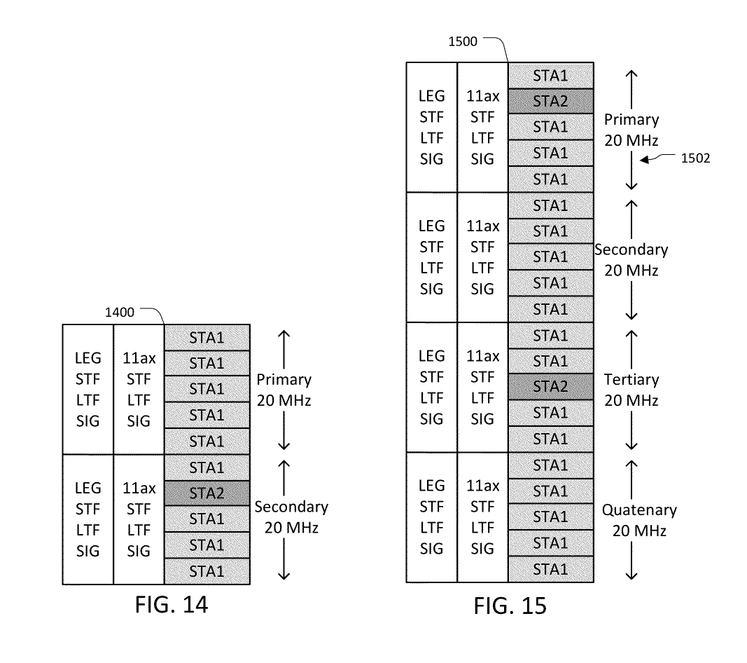

FIG. 14 shows another embodiment in which an AP schedules transmissions from at least two STAs in every non-primary sub-channel of a channel during the multi-access portion of a PPDU 1400. Thus, even though the entire primary sub-channel is occupied by STA1 transmissions, STA2 is scheduled in the secondary sub-channel. FIG. 14 shows a 40 MHz channel, but the same rule can be applied to other channel sizes as well.

In addition, FIG. 14 illustrates a priority rule of an embodiment. In such an embodiment, an AP has a first priority of scheduling at least two STAs in a secondary sub-channel. Next, the AP may have a priority of scheduling at least two STAs in each additional non-primary sub-channel. Further, the AP may have a third priority of scheduling at least two STAs to transmit on a primary sub-channel. The priority rule illustrated in FIG. 14 may be used to protect transmissions in the sub-channels other than the primary channel from transmissions by other stations within a BSS of the AP when the primary sub-channel is protected within the BSS of the AP by other mechanisms (e.g., IEEE 802.11 mechanisms) and the AP does not detect or has not been informed of the presence of another BSS associated with a different AP.

In such an embodiment, the priorities may be selectively applied. For example, multiple STAs may have data to transmit, but some of the STAs may only have a relatively small amount of data while other STAs have a large amount of data. Such a case may result in a transmission like the PPDU 1400 of FIG. 14, in which STA1 is assigned to multiple sub-bands, while STA2 is assigned to only one secondary sub-band.

In still another embodiment, as seen in FIG. 15, an AP schedules at least two STAs on a primary 20 MHz sub-channel as a first priority, and if possible, the AP schedules at least two STAs on one or more non-primary sub-channels. In particular, if a large amount of data is pending for uplink from a first STA, then such an embodiment may not schedule a second STA in the one or more non-primary sub-channels, and may instead devote the entire bandwidth of the one or more non-primary sub-channels to the first STA.

FIG. 15 shows a situation in which a large amount of data is pending for STA1, so STA1 occupies the entire 20 MHz bandwidth of the secondary sub-channel and the quaternary sub-channel during a multi-access portion of the UL OFDMA PPDU 1500. However, the data of STA1 does not occupy all of the bandwidth of the tertiary sub-channel during the multi-access portion, so STA2 is scheduled to transmit on a sub-band of the tertiary sub-channel, as well as on a sub-band of the primary sub-channel, during the multi-access portion.

The determination of whether to schedule transmissions from two specific STAs on two sub-channels during the multi-access portion may depend on a variety of factors, such as the amount of data pending for uplink on each individual STA associated with an AP, a history of network traffic, RSSI values of the STA, etc.

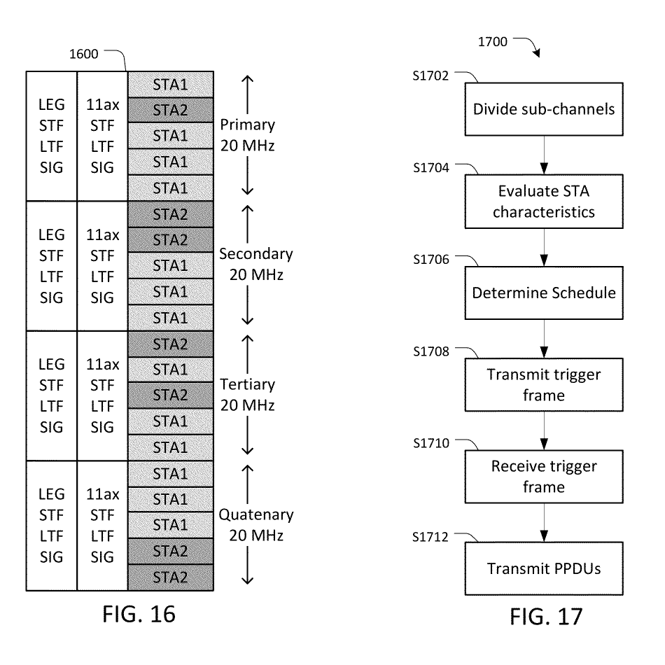

In an embodiment illustrated by FIG. 16, the AP assigns at least two different STAs to the secondary sub-channel during a multi-access portion of an 80 MHz UL OFDMA PPDU 1600. Another embodiment assigns at least two STAs to the secondary sub-channel, and then assigns the at least two STAs to the multi-access portion of each of the tertiary channel and quaternary sub-channel. Still another embodiment combines these rules, and extends them by assigning the at least two STAs to the primary channel during the multi-access portion.

Such embodiments may be implemented in various networks in consideration of an amount of traffic in the network, an amount of STAs in communication with an AP, proximity between STAs, a total coverage area of the UL OFDMA PPDU transmission, the load on a scheduler, an amount of interference, the presence of legacy devices, etc.

Furthermore, the embodiments described here with respect to FIG. 16 may be implemented in channels of various sizes. For example, the rules described above with respect to FIG. 16 may be applied to a 40 MHz channel, a 160 MHz or 80+80 MHz channel.

The priority of assignments may vary between embodiments. For example, a first priority may be to assign at least two STAs to a primary sub-channel during the multi-access portion, and a second priority may be to assign two or more STAs to the secondary sub-channel during the multi-access portion. The second priority may extend to assigning two or more STAs to each sub-channel that is not a primary sub-channel during the multi-access portion, such as the secondary, tertiary and quaternary sub-channels.

In these and other embodiments, even though it is a priority to assign at least two STAs to a sub-channel during the multi-access portion, if conditions are appropriate, the AP may assign as many STAs as possible to a sub-channel during the multi-access portion. When multiple STAs have data to transmit in uplink, an AP may attempt to spread the data across multiple sub-channels to maximize the number of STAs that transmit on a particular sub-channel, and/or to maximize the number of sub-channels on which multiple STAs transmit. Doing so may include balancing data transmission priorities against a policy of maximizing a number of STAs transmitting energy on sub-bands.

In determining which STA to assign to particular sub-channels, an embodiment may use a Received Signal Strength Indication (RSSI) value to determine a priority of each STA. The RSSI value may be an average of RSSI measurements over a number of frames. The number of frames for determining an average value may be, for example, 10 frames or 1000 frames, or may be the most recent frame received from the STA.

In such an embodiment, an AP may assign a STA with a highest RSSI value to transmit on the primary sub-channel. The STA having the highest RSSI value may be the closest STA to the AP, and may have a coverage pattern that includes more of the coverage pattern of the AP than is included in coverage patterns of STAs that are farther away from the AP.

RSSI values may also be used to determine which of a plurality of STA are assigned to various sub-channels in the embodiments described above. For example, when at least two STA are assigned to a sub-channel, the at least two STA may be the two STA with highest RSSI values.

FIG. 17 shows a process 1700 for assigning frequency resources to a plurality of devices in a wireless network. Elements of process 1700 can help explain the embodiments provided above.

Sub-channels are divided, by an AP, into a plurality of sub-bands at S1702. In an embodiment, a sub-channel may be divided by a number of STA in communication with the AP. For example, if a sub-channel is 20 MHz and four STA are communicating through the AP, the 20 MHz sub-channel may be partitioned to four portions (each containing one or more of the sub-bands with minimum size), resulting in four possibly equal-size sub-bands per 20 MHz sub-channel. Similarly, when five STA are communicating through the AP using 20 MHz sub-channels, the sub-channels may be portioned into five portions each containing one or more of the sub-bands with minimum size. For instance, the sub-band with minimum size for an FFT=256 has 26 data tones which roughly has bandwidth of 2 MHz.

In some embodiments, sub-channels are divided by a number of STA up to a limit, after which the sub-bands are a minimum size. For example, if a minimum sub-band size is 4 MHz, then a sub-channel may be divided into 4 MHz sub-bands when five or more STA are in communication with the AP. In still other embodiments, the size of sub-bands may be a set value, or may be determined based on other factors of the network.

Characteristics of one or more STAs may be determined at S1704. In one embodiment, the STA characteristic that is determined is an RSSI value, which may be an average value. The RSSI value may be used to determine which STA are assigned to particular sub-channels. For example, STA with higher RSSI values may have priority for assignment to a primary sub-channel.

Another characteristic that may be determined is whether a STA in the coverage area of the AP is a legacy device. When a legacy device is in the vicinity of an AP, there is a greater chance that the legacy device will transmit a colliding frame when coming out of sleep mode. Accordingly, elements of this disclosure may be selectively implemented based on whether a legacy node is known to be present in the coverage area of an AP.

A PPDU transmission schedule is determined, by the AP, at S1706. Determining the transmission schedule includes assigning each of a plurality of STA to transmit in particular sub-bands of sub-channels of UL OFMDA PPDUs during respective multi-access portions of the UL OFDMA PPDUs.

After a schedule is determined, the AP may send assignments to STA in a trigger frame that are transmitted at S1708. The trigger frame is received by one or more STAs at S1710. Each of the one or more STAs may process the trigger frames to determine respective assignments for one or more upcoming UL OFDMA transmissions. The one or more STAs may then each transmit an UL OFDMA PPDU to the AP at S1712.

Although various embodiments have been described above with respect to uplink, aspects of the embodiments may be applied to downlink (DL) as well. An AP may apply aspects of this disclosure in order to avoid interference from other devices, including other 802.11 wireless devices.

In other embodiments, the rules explained above might be used by an AP for resource assignment in DL OFDMA PPDUs. In some cases, the AP might decide to do so to perform some interference management techniques to avoid causing interference to other wireless nodes that might partially or fully use the same channel as the AP and the BSS (i.e., wireless frames are detected by the AP from an overlapping basic service set (OBSS)). In this set of embodiments, the AP may first detect/identify the sub-bands or 20 MHz sub-channels that cause interference and then avoid/preclude transmission on the sub-bands that fully or partially overlap with the bands that are contaminated with the detected interference sources.

In some embodiments, the above approach leads to not scheduling any UL transmission for any STA in the sub-bands with bandwidths of 2 MHz, 4 MHz or 8 MHz. In some other embodiments, the above approach leads to not scheduling any UL transmission for any STA in one or more of the 20 MHz sub-channels. In these embodiments, an AP might leave one of the non-primary (non-primary 20 MHz) sub-channels without any assignment. This would mean that all the sub-bands in such 20 Mhz sub-channels left without assignment and no energy is emitted in corresponding sub-bands of these 20 MHz sub-channels in the case of a DL OFDMA frame (except in some cases during the legacy PHY header and any additional PHY header (e.g., IEEE 802.11ax PHY header)), or no UL assignment is scheduled for these 20 MHz sub-channels in the case of an UL OFDMA frame.

As an example of the above embodiments, an AP schedules for a DL or UL OFDMA frame (and announces this assignment in the HE SIG-B or another signaling field of the DL frame or in a trigger frame (i.e., a frame that immediately precedes a UL multi-user transmission) to a set of STAs), where the set of assignment for the STAs may not cover some of the 20 MHz sub-channels at which the AP and the associated BSS operate. This lack of assignments may result in a non-contiguous set of 20 MHz sub-channels for a transmission.

In some other embodiments, an AP might leave one of the non-primary 20 Mhz sub-channels and non-secondary 20 MHz sub-channels without any assignment and no energy is emitted in these sub-bands (except in some cases during the legacy and any other PHY headers (e.g., IEEE 802.11ax PHY header)). In some embodiments, the above-mentioned source of interference could be other APs with partially overlapping frequency bands with that of the AP. In some other embodiments, the above-mentioned source of interference could be other APs with fully overlapping but narrower frequency bands with that of the AP. For instance, an 80 MHz AP operates at the set of 20 MHz sub-channels (A,B,C,D) and a 20 MHz AP operates at either of channels A, B, C, or D. In another instance, an 80 MHz AP operates at the set of 20 MHz sub-channels (A,B,C,D) and a 40 MHz AP operates at either of channels (A, B), or (B,C) or (C,D). In these instances, the above-mentioned techniques can be used for scheduling DL and UL OFDMA.

In these embodiments, the AP would first identify the frequency bands on which such sources of interference operate, and then avoid assigning STA on sub-bands that fully or partially overlap with the bands that include the detected interference.

In some other embodiments, the source of interference to be avoided could be another AP whose frequency bands partially overlap with bands of the AP. In some other embodiments, the source of interference could be other APs whose frequency bands fully overlap with but are narrower than a frequency band used by the target AP.

In some other embodiments, an AP might leave one of the non-primary (non-primary 20 MHz) and non-secondary (non-secondary 20 MHz) 20 Mhz sub-channels without any assignment. In such an embodiment, all the sub-bands in such a 20 Mhz sub-channel are left without assignment and no energy is emitted in these sub-bands. In one particular embodiment, the only energy in those sub-bands is the legacy PHY header and the 11ax PHY header. In some other embodiments, an AP might leave one of the non-primary 20 Mhz bands without any assignment, and no energy is emitted in these sub-bands, except possibly during legacy and 11ax PHY headers.

In above explanations and figures, illustrative embodiments were provided to allow a person of skill in the art to understand and implement embodiments of the disclosure. However, embodiments are not limited thereto, and are therefore not limited to the number of STAs, specific identifications, specific formats, specific number of STAs per identifications, or other specifics of the illustrative embodiments. Furthermore, while in the description and related figures the reference has made to one or more IEEE Std 802.11 standards, embodiments are not limited thereto, and a person of skill in the art in light of the teachings and disclosures herein would understand how the present disclosures apply to any wireless operation that operates in licensed or unlicensed bands.

Embodiments of the present disclosure include electronic devices configured to perform one or more of the operations described herein. However, embodiments are not limited thereto.

Embodiments of the present disclosure may further include systems configured to operate using the processes described herein. The systems may include basic service sets (BSSs) such as the BSS 1000 of FIG. 10, but embodiments are not limited thereto.

Embodiments of the present disclosure may be implemented in the form of program instructions executable through various computer means, such as a processor or microcontroller, and recorded in a non-transitory computer-readable medium. The non-transitory computer-readable medium may include one or more of program instructions, data files, data structures, and the like. The program instructions may be adapted to execute the processes and to generate and decode the frames described herein when executed on a device such as the wireless devices shown in FIG. 1.

In an embodiment, the non-transitory computer-readable medium may include a read only memory (ROM), a random access memory (RAM), or a flash memory. In an embodiment, the non-transitory computer-readable medium may include a magnetic, optical, or magneto-optical disc such as a hard disk drive, a floppy disc, a CD-ROM, and the like.

While this invention has been described in connection with what is presently considered to be practical embodiments, embodiments are not limited to the disclosed embodiments, but, on the contrary, may include various modifications and equivalent arrangements included within the spirit and scope of the appended claims. The order of operations described in a process is illustrative and some operations may be re-ordered. Further, two or more embodiments may be combined.

What is claimed is:

1. A method for a wireless communications system in which an access point wirelessly communicates with a plurality of stations over a wireless channel, the method comprising:
transmitting a frame, including a schedule from the access point to a plurality of stations, the schedule including assignments of one or more sub-bands in at least one sub-channel of the wireless channel to each station in the plurality of stations,
wherein each station in the plurality of stations uses the assigned sub-band for a multi-user, simultaneous communication with the access point.

2. The method of claim 1, wherein the one or more sub-bands are assigned from a primary channel of the wireless channel.

3. The method of claim 1, wherein the wireless channel includes a plurality of sub-channels and one or more sub-bands are assigned to each station in the plurality of stations from each of the plurality of sub-channels such that the each station in the plurality of stations is assigned at least one sub-band in each of the plurality of sub-channels.

4. The method of claim 3, wherein each sub-channel in the plurality of sub-channels is a 20 MHz channel.

5. The method of claim 1, wherein the wireless channel includes a plurality of sub-channels, and
wherein sub-bands in one or more sub-channels of the plurality of sub-channels are assigned to at least two separate stations in the plurality of stations.

6. The method of claim 5, wherein one sub-channel in the plurality of sub-channels is a primary sub-channel such that all transmissions on the wireless channel includes the primary sub-channel,
wherein the assignment of sub-bands, in one or more sub-channels of the plurality of sub-channels to at least two separate stations in the plurality of stations, prioritizes the primary sub-channel over the other sub-channels in the plurality of sub-channels.

7. The method of claim 5, wherein one sub-channel in the plurality of sub-channels is a primary sub-channel such that all transmissions on the wireless channel includes the primary sub-channel,
wherein the assignment of sub-bands, in one or more sub-channels of the plurality of sub-channels to at least two separate stations in the plurality of stations, prioritizes a sub-channel other than the primary sub-channel.

8. The method of claim 5, wherein (1) one sub-channel in the plurality of sub-channels is a primary sub-channel such that all transmissions on the wireless channel includes the primary sub-channel and (2) one sub-channel in the plurality of sub-channels is a secondary sub-channel such that all transmissions that are double a bandwidth of the primary sub-channel includes the secondary sub-channel,
wherein the assignment of sub-bands, in one or more sub-channels of the plurality of sub-channels to at least two separate stations in the plurality of stations, prioritizes the secondary sub-channel over the other sub-channels in the plurality of sub-channels.

9. The method of claim 1, further comprising:
determining a set of stations in the plurality of stations with a highest signal strength over a period of time,
wherein one or more stations from the set of stations is assigned to one or more sub-channels in the plurality of sub-channels.

10. The method of claim 9, wherein one sub-channel in the plurality of sub-channels is a primary sub-channel such that all transmissions on the wireless channel includes the primary sub-channel,
wherein the assignment of the one or more stations from the set of stations to one or more sub-channels in the plurality of sub-channels prioritizes the primary sub-channel over the other sub-channels in the plurality of sub-channels.

11. The method of claim 1, wherein the schedule is represented in one of (1) a trigger frame, which schedules an uplink transmission from the plurality of stations, and (2) a signaling field of a downlink multi-user transmission from the access point to the plurality of stations.

12. The method of claim 1, wherein the wireless channel includes a plurality of sub-channels, and
wherein at least two stations in the plurality of stations is assigned to each sub-channel in the plurality of sub-channels.

13. The method of claim 1, further comprising:
detecting an interfering wireless signal from a device outside a basic service set (BSS) of the access point, the interfering wireless signal at least partially occupies one or more sub-bands of one or more sub-channels of the wireless channel; and
precluding assignment of the one or more sub-bands, upon which the interfering wireless signal is detected, to a station in the plurality of stations in response to/detecting the interfering wireless signal.

14. The method of claim 13, wherein the schedule indicates that the one or more sub-bands, upon which the interfering wireless signal is detected, are avoided for multi-user, simultaneous communication with the access point while other sub-bands, upon which the interfering wireless signal has not been detected, are used for multi-user, simultaneous communication with the access point.

15. The method of claim 14, wherein the schedule indicates a non-contiguous set of sub-channels upon which multi-user, simultaneous communication is conducted with the access point.

16. A method for a wireless communications system in which an access point wirelessly communicates with a plurality of stations, the method comprising:
transmitting a frame including a schedule from the access point to a plurality of stations, the schedule including assignment of at least one station in the plurality of stations to at least one sub-band in each sub-channel of a wireless channel occupied by the frame,
wherein each station in the plurality of stations uses the assigned sub-band for a multi-user, simultaneous communication with the access point.

17. The method of claim 14, wherein each sub-channel of the wireless channel is assigned at least one common station from the plurality of stations.

18. The method of claim 14, wherein each sub-channel of the wireless channel is assigned a different station from the plurality of stations.

19. The method of claim 14, wherein at least two sub-channels of the wireless channel are assigned different stations from the plurality of stations.

20. The method of claim 14, wherein the schedule includes assignment of at least two stations in the plurality of stations to at least two sub-bands in each sub-channel of a wireless channel occupied by the frame.
